(19) United States
(12) Patent Application Publication
(10) Pub. No.: US 2011/0202297 A1
(43) Pub. Date: Aug. 18, 2011

(54) PRODUCT SORTING METHOD BASED ON QUANTITATIVE EVALUATION OF POTENTIAL FAILURE

(75) Inventors: Kunhan KIM, Yongin-si (KR); Inkap Chang, Suwon-si (KR); Seunghoon Tong, Seoul (KR); Seungsik Jung, Seoul (KR)

(73) Assignee: Samsung Electronics Co., Ltd.

(21) Appl. No.: 13/028,782

(22) Filed: Feb. 16, 2011

(30) Foreign Application Priority Data
Feb. 18, 2010 (KR) 10-2010-0014753

(51) Int. Cl. G06F 19/00

(52) U.S. Cl. 702/82

(57) ABSTRACT

Provided is a product sorting method based on the quantitative evaluation of a potential failure. The product sorting method manufactures a plurality of independent products with a manufacture device. The product sorting method obtains test records for the respective products by testing the products with a test device. The product sorting method determines whether the products are good products or fail products by analyzing the test records with a failure determination device. The product sorting method calculates a quality index which defines the possibility of potential failure of a population comprising the tested products as one value, by analyzing the test records with a quality index calculation device. The product sorting method determines whether to perform a subsequent operation for products which are determined as the good products by analyzing the quality index with a product sorting device.

### CROSS-REFERENCE TO RELATED APPLICATIONS

This U.S. non-provisional patent application claims priority under 35 U.S.C. §119 of Korean Patent Application No. 10-2009-0014753, filed on Feb. 18, 2010, the entire contents of which are hereby incorporated herein by reference.

### BACKGROUND

The present disclosure herein relates to a product quality evaluating method, and more particularly, to a product quality evaluating method and a product sorting method using the same, which can filter a potential failure.

Generally, manufacturers endeavor to sell only good products, which are sorted as normally operating from among manufactured products, to users. Most manufacturers carry out a good product sorting operation using any means possible in that the good product sorting operation maintains or increases the manufacturers' reputation.

Even products, which have been sorted as good products and sold, may not normally operate later as time elapses or the number of use times increases. That is, although there is a difference between times when failures occur, most products do not normally operate sooner or later. For establishing clear-cut lines of responsibility to the after-sales failures of sold products, manufacturers provide information on the terms of endurance or warranty periods of products that are sold, to users. That is, when a sold product does not normally operate within its warranty period, a manufacturer should provide after-sales service for the sold product in response to users' complaints. However, in that the after-sales service causes the waste of resources and the decrease of manufacturers' reputation, many manufacturers apply an operation of evaluating the possibilities of potential failures of products to be sold, as a portion of a product sorting operation.

### SUMMARY

The present disclosure provides a product quality evaluating method, which can filter a potential failure in advance.

The present disclosure also provides a product quality evaluating system, which can filter a potential failure in advance.

The present disclosure also provides a product sorting method, which can sort products having potential failures in advance.

Embodiments of the inventive concept provide a product sorting method comprising: manufacturing a plurality of independent products with a manufacture device; obtaining test records for the respective products by testing the products with a test device; determining whether the products are good products or fail products by analyzing the test records with a failure determination device; calculating a quality index which defines possibility of potential failure of a population comprising the tested products as one value, by analyzing the test records with a quality index calculation device; and determining whether to perform a subsequent operation for products which are determined as the good products by analyzing the quality index with a product sorting device.

In some embodiments, the products may configure a plurality of product groups which are independently manufactured in the manufacture device, all products comprised in one product group may be manufactured through substantially same manufacture process stages, and the population may comprise products which are comprised in one product group.

In other embodiments, a relative location between the products, which are comprised in one product group, may be fixed while the products are being manufactured.

In still other embodiments, the calculating of a quality index may comprise: grouping the test records; and calculating the quality index by analyzing the grouped test records through robust estimation.

In even other embodiments, the quality index calculated through the robust estimation may be any one of an M-estimator, a a-trimmed estimator, an R-estimator, an L-estimator and a Winsorised estimator.

In yet other embodiments, the products may configure a plurality of product groups which are independently manufactured in the manufacture device, all products comprised in one product group may be manufactured through substantially same manufacture process stages, and the grouping of the test records may comprise grouping the test records in product group units.

In further embodiments, the grouped test records may comprise test records obtained from the same test item, for all products satisfying all two cases below: (1) products which are manufactured through the substantially same manufacture process stages (2) products in which a relative location is fixed during the manufacture process stage.

In still further embodiments, the product sorting method may further comprise grouping the test records, and removing an outlier from the grouped test records.

In even further embodiments, the testing of the products may comprise measuring qualities of the products for a plurality of test items, and the quality index may be calculated as one value for each of the test items.

In yet further embodiments, the product sorting method may further comprise calculating a cluster index which defines a fail clusteringness of the population as one value, by analyzing the test records with a cluster index calculation device.

In yet further embodiments, the calculating of a cluster index may comprise: binarizing the test records; filtering the binary-coded test records; and calculating the cluster index from the filtered test records.

In yet further embodiments, the product sorting method may further comprise: additionally determining whether to perform a subsequent operation for products which are sorted to perform a subsequent operation through an analysis of the quality index, by analyzing the cluster index with the product sorting device.

In yet further embodiments, the products may configure a plurality of product groups which are independently manufactured in the manufacture device, all products comprised in one product group may be manufactured through substantially same manufacture process stages, and the cluster index may be calculated as one value for each of the product groups.

### BRIEF DESCRIPTION OF THE DRAWINGS

The accompanying drawings are comprised to provide a further understanding of the inventive concept, and are incorporated in and constitute a part of this specification. The drawings illustrate exemplary embodiments of the inventive concept and, together with the description, serve to explain principles of the inventive concept. In the drawings:

FIGS. 1 through 4 are diagrams for describing the kinds or qualities of products to which a method for evaluating the possibility of potential failure of a product according to embodiments of the inventive concept is applied;

FIG. 5 is a diagram for exemplarily describing a technical effect which is intended by a method for evaluating the possibility of a potential failure according to embodiments of the inventive concept;

FIG. 6 is a flowchart for describing a method for evaluating the possibility of potential failure of a product by using sorted items, according to an embodiment of the inventive concept;

FIG. 7 is a diagram for describing the structure of data which is obtained through the method of FIG. 6;

FIG. 8 is a flowchart for describing a method for evaluating the possibility of potential failure of a product and a product sorting method using the same according to an embodiment of the inventive concept;

FIG. 9 is a flowchart for exemplarily describing a quality index calculation algorithm in a method for evaluating the possibility of potential failure of a product according to an embodiment of the inventive concept;

FIGS. 10 and 11 are diagrams for exemplarily describing in more detail the each operation of a quality index calculation algorithm;

FIG. 12 is a diagram for describing the structure of data which is obtained through a method for evaluating the possibility of potential failure of a product according to an embodiment of the inventive concept;

FIG. 13A is a graph illustrating a result which is obtained from a method for evaluating the possibility of potential failure of a product using sorted items;

FIG. 13B is a graph illustrating a result which is obtained from a method for evaluating the possibility of potential failure of a product according to an embodiment of the inventive concept;

FIG. 14 is a flowchart for describing a method for evaluating the possibility of potential failure of a product and a product sorting method using the same according to another embodiment of the inventive concept;

FIG. 15 is a flowchart for exemplarily describing a cluster index calculation algorithm in a method for evaluating the possibility of potential failure of a product according to another embodiment of the inventive concept;

FIGS. 16 through 18 are diagrams for exemplarily describing in more detail the each operation of a cluster index calculation algorithm which will be described below with reference to FIG. 15;

FIGS. 19A though 19D illustrate data maps exemplarily showing a result which is obtained from the each operation of a cluster index calculation algorithm which will be described below with reference to FIG. 15; and

FIGS. 20A through 20C are graphs exemplarily showing the superiority of a cluster index according to an embodiment of the inventive concept.

### DETAILED DESCRIPTION OF THE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Exemplary embodiments may be embodied as methods, systems, and/or computer program products. Accordingly, exemplary embodiments may be embodied in hardware and/or in software (including firmware, resident software, micro-code, etc.). Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Hereinafter, exemplary embodiments of the inventive concept will be described in detail with reference to the accompanying drawings.

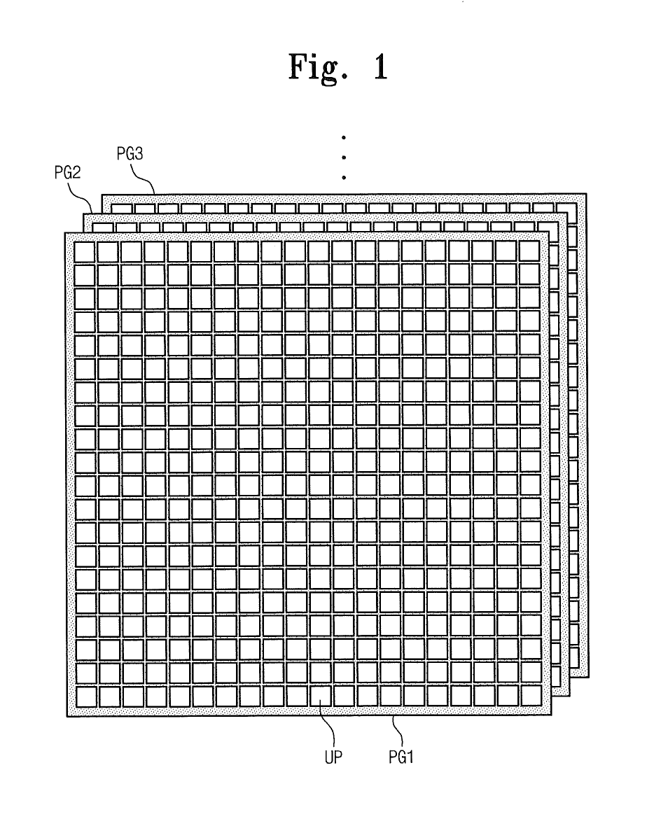

FIGS. 1 through 4 are diagrams for describing the kinds or qualities of products to which a method for evaluating the possibility of potential failure of a product according to embodiments of the inventive concept is applied.

Referring to FIG. 1, a method for evaluating the possibility of a potential failure (defect) according to embodiments of the inventive concept may be applied to unit products UP configuring product groups PG1 to PG3 (PG). The unit products UP configuring the product group PG may be grouped in various sorting schemes (like a period of manufacture, a manufacture method and a manufacture device). In a known lot system, one lot may correspond to the product group PG, and products configuring one lot may correspond to the unit products UP configuring one product group PG.

According to an embodiment of the inventive concept, each of the product groups PG may be manufactured through an independent manufacture process, the unit products UP configuring the respective product groups PG may be controlled through the substantially same manufacture process stages. That is, all unit products UP comprised in one product group PG are manufactured while substantially identically undergoing process stages for manufacturing them, but unit products UP comprised in different product groups PG, as results that are obtained through the independent manufacture processes, may be manufactured while differently undergoing process stages for manufacturing them.

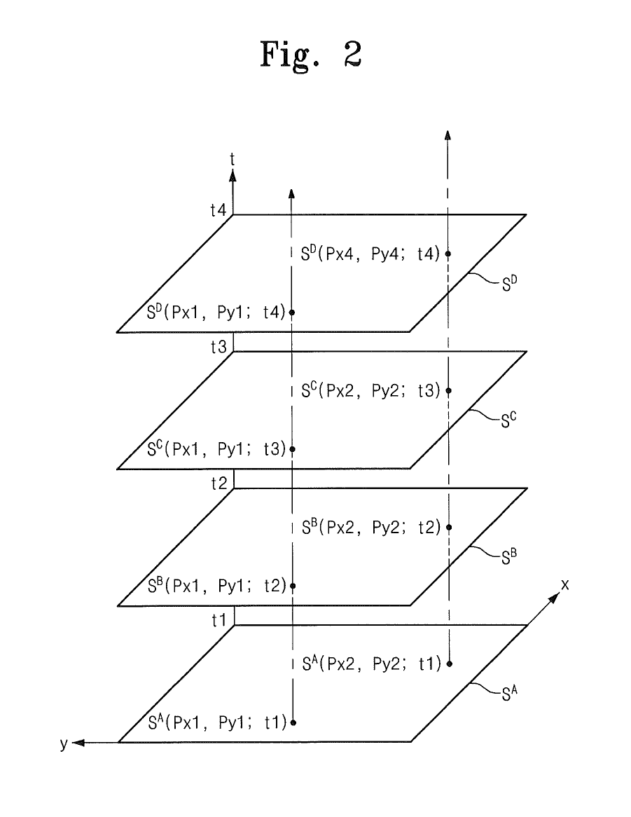

In addition, unit products UP configuring one product group PG may have invariability in a relative location between them, during a series of process stages for manufacturing them. Unit products having such a feature may comprise micro devices that are formed on one substrate using Microelectromechanical Systems (MEMS), Light Emitting Diodes (LEDs) that are integrated on one substrate, touch screens that are integrated on one substrate, and semiconductor chips that are integrated on one substrate. As a more detailed example, as illustrated in FIG. 2, respective LEDs integrated on one substrate may be manufactured through a plurality of process stages S^{A}(t1), S^{B}(t2), S^{C}(t3) and S^{D}(t4) that are performed at different times t1 to t4, but while the process stages are being performed, coordinates defining the locations of respective unit products UP may not substantially be changed (i.e., Px1(t1)=Px1(t2)=Px1(t3)=Px1(t4) and Py1(t1)=Py1(t2)=Py1(t3)=Py1(t4)). In this case, LEDs integrated on one substrate may configure one product group PG. The micro devices using the MEMS, the touch screens and the semiconductor chips may also be comprised in the type of the product that has been described above with reference to FIG. 2.

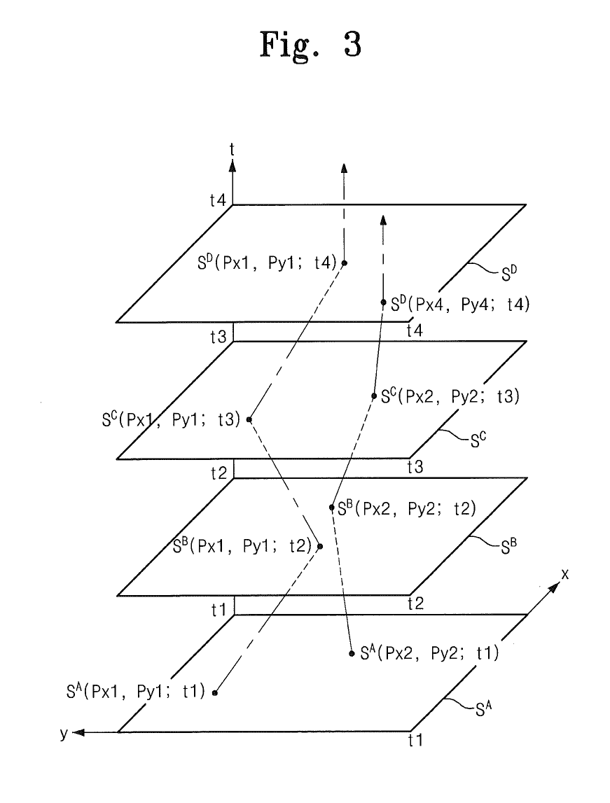

According to another aspect of the inventive concept, however, a method for evaluating the possibility of potential failure of a product to be described below may also be applied to variable unit products UP like that relative locations are illustrated in FIG. 3, in manufacture stages. Products comprising materials having fluid or viscosity may be applied to unit products UP having such a type. For example, the products may comprise chemical industry products such as cosmetics, medicines and plastic products. Alternatively, like hand phones, cars and notebooks, products that are completed by assembling many components may have the feature.

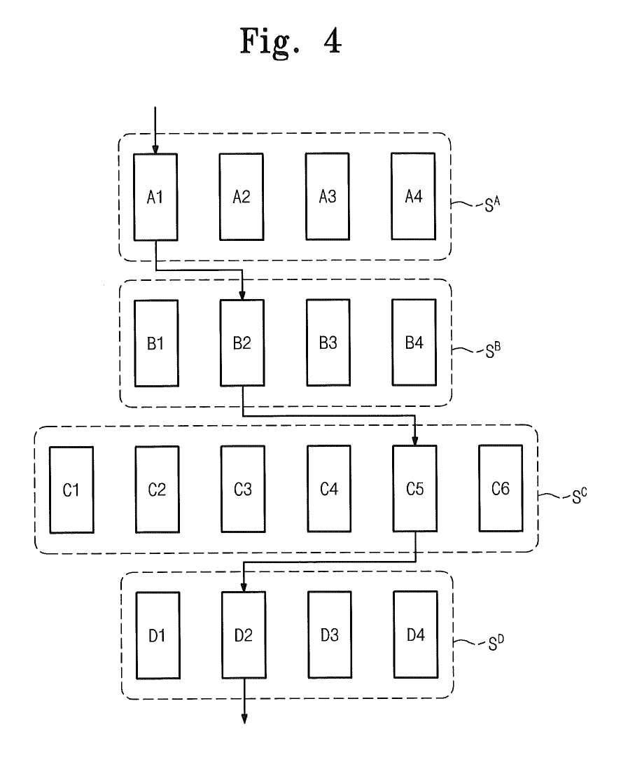

More specifically, in the case of a hand phone comprising components A to D, as illustrated in FIG. 4, the component A may be manufactured using any one of a plurality of manufacture devices and be mounted on a hand phone. Alternatively, the component A may be assembled as one component of a hand phone by using any one of a plurality of assembly devices. Similarly to the component S, other components B to D may also be manufactured or assembled. In this case, the components A to D may be changed like that relative locations are illustrated in FIG. 3, in respective manufacture stages. In the case of the hand phone, in the method for evaluating the possibility of a potential failure according to embodiments of the inventive concept, product groups may be differently grouped according to whether a product to be evaluated is a hand phone or each component. That is, when evaluating the possibility of potential failure of a hand phone, one product group may be configured with the components A to D configuring one hand phone. When evaluating the possibility of potential failure of the component A, one product group may be configured with a plurality of components A that are mounted on different hand phones. Evaluating the possibility of potential failure of the component A may be performed making a manufacture device for the components or an assembly device for the components unit.

Up to now, the kinds or qualities of products, to which the method for evaluating the possibility of a potential failure according to embodiments of the inventive concept may be applied, have been described with reference to FIGS. 1 through 3. However, this has merely been described for understanding the spirit and scope of the inventive concept as an example and does not mean that the spirit and scope of the inventive concept may be restrictively applied to the above-described products. That is, the method for evaluating the possibility of a potential failure according to embodiments of the inventive concept may be applied as-is or be modified and applied to products that are mass-produced in consideration of the quality of a corresponding product or based on the spirit and scope of the inventive concept that have been described above and will be described below.

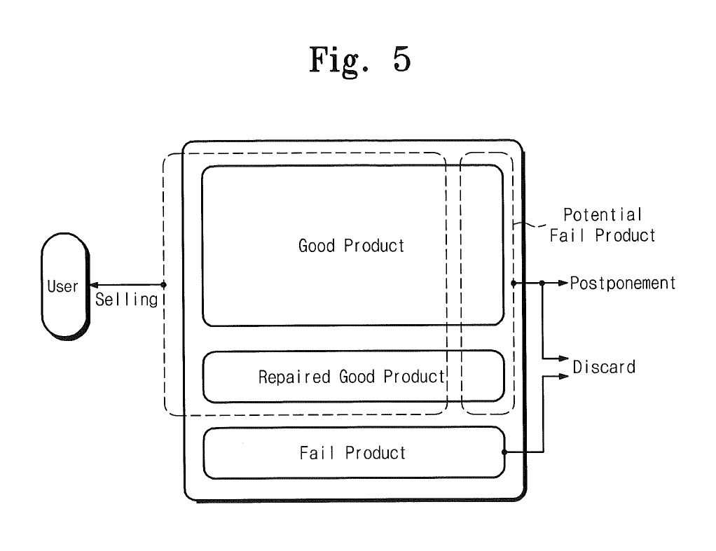

FIG. 5 is a diagram for exemplarily describing a technical effect which is intended by the method for evaluating the possibility of a potential failure according to embodiments of the inventive concept.

Referring to FIG. 5, when mass-producing products, the products are tested through a certain test stage and are thereby divided good products to be sold to users and otherwise fail products. A portion of fail products may be normally operated through a certain repair stage, and products that have been repaired through the repair stage are generally sold to users.

As described above, even good products or repaired good products may not normally operate later as time elapses or the number of use times increases. Consequently, a manufacturer or a seller notifies a period (i.e., a warranty period) for guaranteeing the normal operation of a sold product at the same time with the selling of a corresponding product. However, a portion of good products or repaired good products has the possibility of potential failure that it does not normally operate due to various factors before a warranty period expires. Such potential fail products cause the waste of resources for after-sales service and the decrease of manufacturers' reputation.

Methods for evaluating the possibility of potential failure of a product according to embodiments of the inventive concept, which will be described below, may be used to sort potential fail products from among products that have been primarily sorted as good products or repaired good products. The potential fail products may be discarded or postponed through an additional analysis or sorting operation.

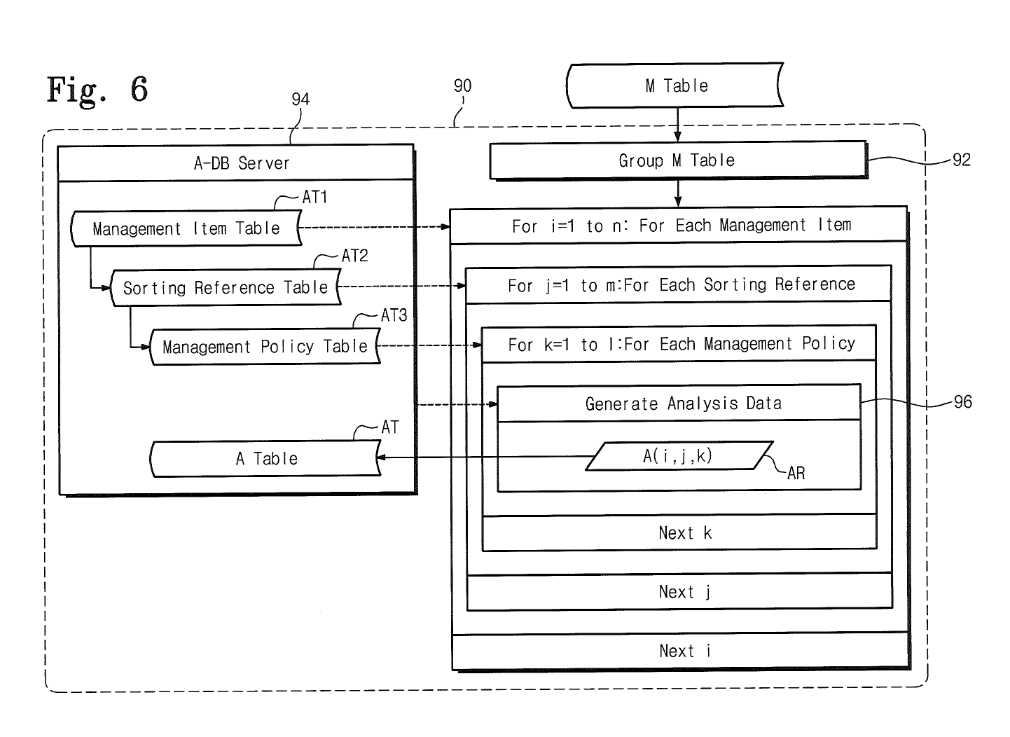

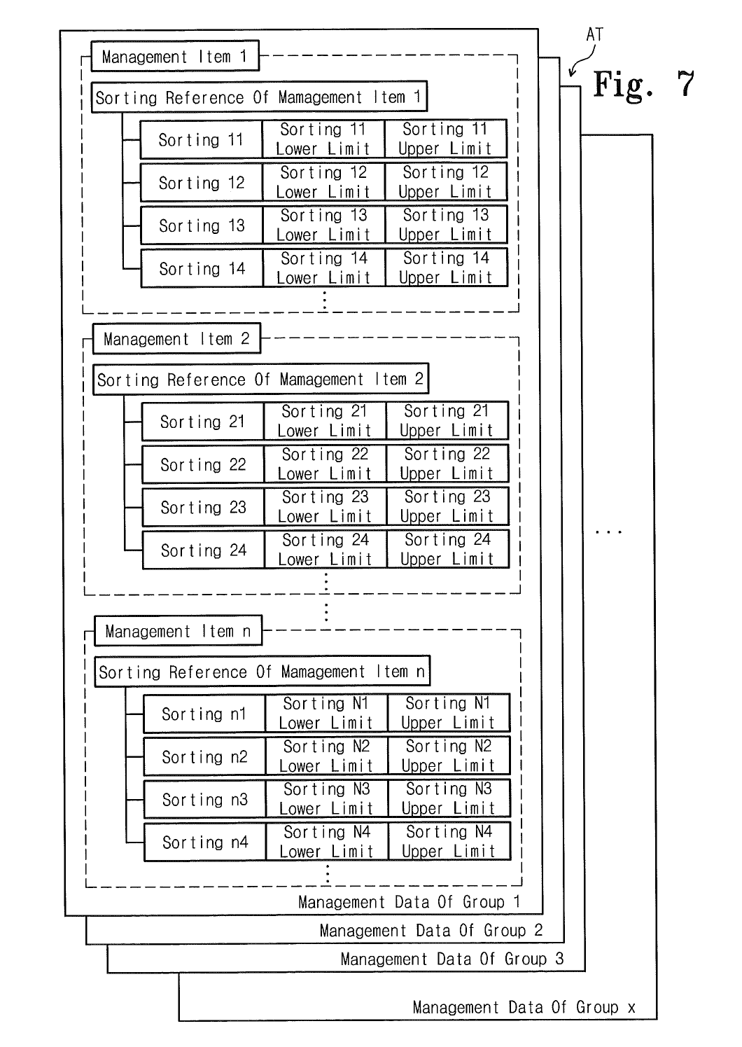

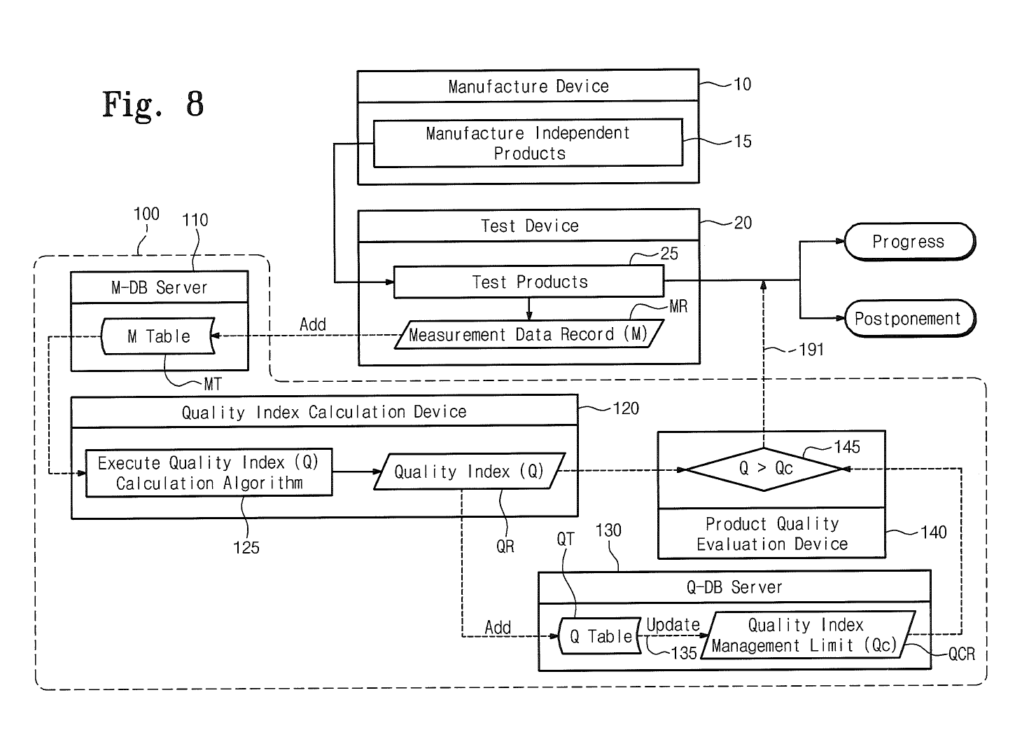

FIG. 6 is a flowchart for describing a method for evaluating the possibility of potential failure of a product by using sorted items, according to an embodiment of the inventive concept. FIG. 7 is a diagram for describing the structure of data which is obtained through the method of FIG. 6, FIGS. 6 and 7 are provided for comparison with a method for evaluating the possibility of potential failure of a product according to embodiments of the inventive concept which will be described below. According to modified embodiments of the inventive concept, however, evaluation methods that will be described below with reference to FIG. 6 may be performed together with methods for evaluating the possibility of potential failure of a product according to embodiments of the inventive concept that will be described below with reference to FIGS. 8 through 14.

For better understanding on the spirit and scope of the inventive concept, a plurality of touch screens integrated on a transparent substrate will be described below as an example of the unit product. The respective touch screens may comprise first transparent interconnections and second transparent interconnections that cross the first transparent interconnections. A user's touch may be determined by sensing the presence of contact between the first and second transparent interconnections or sensing the change of an electrostatic capacity. Accordingly, intersection points between the first and second transparent interconnections may configure a plurality of unit touch regions that are distinguished. In the case of an embodiment of such a touch screen device, it may be understood that a set of touch screen devices integrated on one transparent substrate configures one product group. That is, one transparent substrate may be a criterion for determining the product group.

Referring to FIG. 6, a method for evaluating the possibility of potential failure according to an embodiment of the inventive concept may comprise an operation of obtaining a Measurement Table (MT) by testing manufactured products with a certain test device. The test may comprise at least one measurement operation of measuring the quality of a corresponding product, in at least one test item. A measurement result obtained through a one-time measurement operation or a measurement result in one test item may configure measurement records configuring the measurement table. In the case of an embodiment of the touch screen device, the at least one test item may further comprise (1) a test item for checking whether the touch regions operate normally or (2) a test item for evaluating electrical connection quality between the first and second interconnections and input/output terminals.

Subsequently, the measurement records comprised in the measurement table may be grouped according to a predetermined reference in operation 92. The grouping may be performed on the basis of a product group. The product group may be determined in consideration of the manufacture operation and production method of a corresponding product, as described above with reference to FIGS. 1 through 4. In the case of an embodiment of the touch screen device, one grouped measurement records may be configured with measurement results that are obtained from touch screen devices integrated on one transparent substrate. When the measurement table is stored in a database server, the grouping may be obtained through a certain query expression that specifies the identification (ID) of a corresponding transparent substrate.

By analyzing the grouped measurement records according to certain items, Analysis Records (ARs) are generated in operation 96. The analysis records may be generated by statistically analyzing the grouped measurement records on the basis of a series of information on analysis items that are stored in an analysis database (A-DB) server 94. A series of information on the analysis items may comprise management item information that defines a statistical management method for a corresponding test item, sorting reference information that defines a reference for statistical sorting in a corresponding management item, and management policy information that defines a management policy for a corresponding reference. As illustrated, the management item information, the sorting reference information and the management policy information may be information having a hierarchical structure, and may be stored in a management item table AT1, a sorting reference table AT2 and a management policy table AT3, respectively. When the information has a hierarchical structure, as illustrated, the grouped measurement records may be statistically processed using a plurality of loop sentences (which are based on the management item information, the sorting reference information and the management policy information) and be thereby generated as Analysis Records (ARs). The generated analysis records may be stored as new information in a certain storage device. For example, the generated analysis records may be added as new record to an Analysis Table (AT) that is stored in the analysis database server 94.

The structure of the information and a method for generating the analysis records may be variously modified according to the kind of a corresponding product and the kind of a test item. Nevertheless, since the analysis records are obtained by sorting grouped measurement records that are obtained from one test item on the basis of many sorting items, the analysis table comprises records which respectively correspond to a plurality of sorting items (as the lower-layer data structure of each management item), as exemplarily illustrated in FIG. 7. However, each data, which is obtained as the result of the item sorting scheme, is not information on a population that is configured with all the grouped measurement records but is information on a portion of the population.

Specifically, a Statistical Bin Limits (SBL) technique is one of methods that evaluate the possibility of potential failure of a product using sorting items. However, in the SBL technique, the value of one sorting item or one bin value is not a representative value that is obtained from total unit products configuring one product group, as described above. As a result, in the SBL technique, it is difficult to use one bin item for validly evaluating the possibility of potential failure of a product on the basis of a product group, in one aspect. That is, one bin value is only a value that is obtained from a portion of unit products comprised in one product group. Hereinafter, such an aspect will be called the incompleteness of analysis information.

Furthermore, in the case of the SBL technique, since an evaluator manages a number of bin items, the efficiency of an evaluation operation can decrease. For example, in the case of a semiconductor chip, hundreds kinds of bin items may be defined for evaluating the possibility of a potential failure. Hereinafter, such an aspect will be called “the decrease of efficiency of an evaluation operation”.

In the SBL technique, moreover, when bin items are not defined to appropriately reflect the quality of a corresponding product or a corresponding test item, the accuracy of an evaluation result can decrease. That is, the validity of an evaluation result that is obtained through the SBL technique may be dependent on a definition scheme. Hereinafter, such an aspect will be called “the decrease of accuracy of an evaluation result”. As described above, a number of bin items may be defined for one product, and since most of the bit items are defined based on an engineer's experience, the validity of the SBL technique becomes dependent on the level of the engineer's experience. Such an aspect may be another reason that causes the incompleteness of the above-described analysis information.

In the case of the SBL technique, if corresponding data (i.e., a bin value) deviates from a predetermined reference in at least one of sorting items (i.e., bin items), comprised may be an operation of evaluating that a corresponding product group has the high possibility of a potential failure. For this, however, predetermined upper limits and lower limits, as a criterion for comparison with a bin value obtained, should be defined for respective bin items. As a result, in the SBL technique, a plurality of upper limits and lower limits as well as a plurality of bin items should be additionally defined. However, since such additional definition denotes that the number of necessary management items increases, the decrease of efficiency of the evaluation operation can be more deepened. Furthermore, when references (i.e., the upper limits and the lower limits) are not defined to appropriately reflect the quality of a corresponding product or a corresponding test item, the decrease of accuracy of the evaluation result can also be more deepened.

FIG. 8 is a flowchart for describing a method for evaluating the possibility of potential failure of a product and a product sorting method using the same according to an embodiment of the inventive concept.

Referring to FIG. 8, a plurality of products configuring a product group are manufactured with a manufacture device 10 in operation 15, and are tested with a test device 20 in operation 25. According to an embodiment of the inventive concept, unit products UP configuring one product group PG may be configured to have functional identity and functional independence. That is, arbitrary two unit products comprised in one product group PG may be configured to provide the substantially same function, and the unit products UP may be configured to independently operate. For example, the above-described touch screen devices integrated on one substrate or the above-described semiconductor chips integrated on one wafer may be comprised in unit products having the type.

As a Measurement data Record (MR), measurement data obtained as the result of the test operation 25 may be added to the Measurement Table (MT) of a measurement database server 110. A quality index calculation device 120 calculates a quality index Q from the measurement table that is stored in the measurement database server 110. A quality index record QR comprising the quality index Q is added to the quality index table QT of a quality index database server 130, and may be used to update a quality index management record QCR comprising a quality index management limit Qc in operation 135. A product quality evaluation device 140 determines whether to progress unit products PG configuring the product group PG on the basis of the quality index Q in operation 191. Determining whether to progress the unit products in operation 191, as shown in operation 145, may be determined through quantitative comparison between the quality index Q and the quality index management limit Qc.

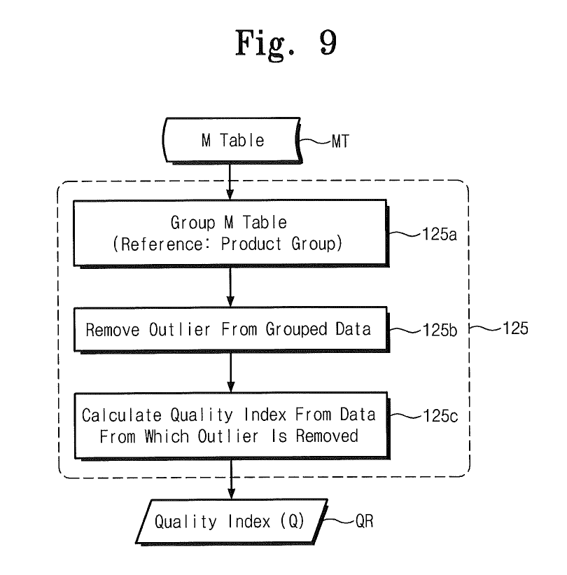

According to this embodiment, the quality index calculation device 120 may be a calculation device comprising an algorithm for calculating the quality index, and may electronically communicate with the measurement database server 110, the quality index database server 130 and the product quality evaluation device 140. An algorithm for calculating the quality index will be described below in more detail with reference to FIG. 9.

The test device 20 may further comprise an identification device that may identify the unit products UP or the product group PG, or an input device that may receive the ID information of the unit products or product group. The test device 20 may further comprise a communication device that may transmit the measurement data record (MR) to the measurement database server 110. Furthermore, at least two of the measurement database server 110, the quality index calculation device 120, the quality index database server 130 and the product quality evaluation device 140 may organically be connected to each other through an electronic scheme so that the manufacture histories and test results of the unit products UP or the product group PG may be inquired. For example, the database servers 110 and 130 may be configured in order to reference the data of different servers in one physical system, through hardware or software. Similarly, at least two of the quality index calculation device 120, the product quality evaluation device 140 and the test device 20 may be configured as parts configuring one physical system. A system having the organic connection or an electronic communication function may be implemented in various schemes. It is apparent that the above-described embodiment has merely, exemplarily described a method of implementing the system and does not limit the spirit and scope of the inventive concept.

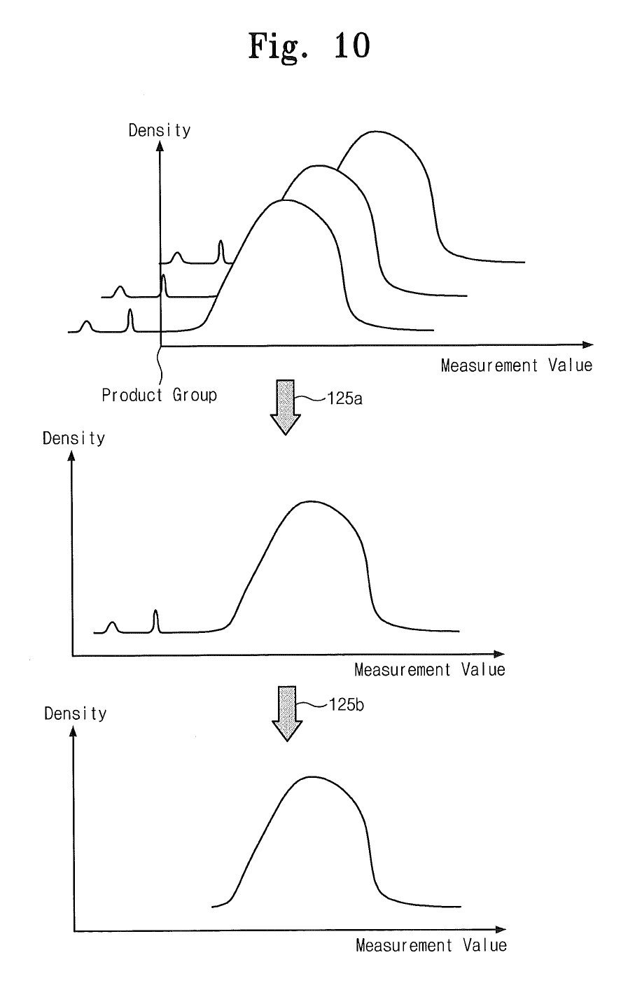

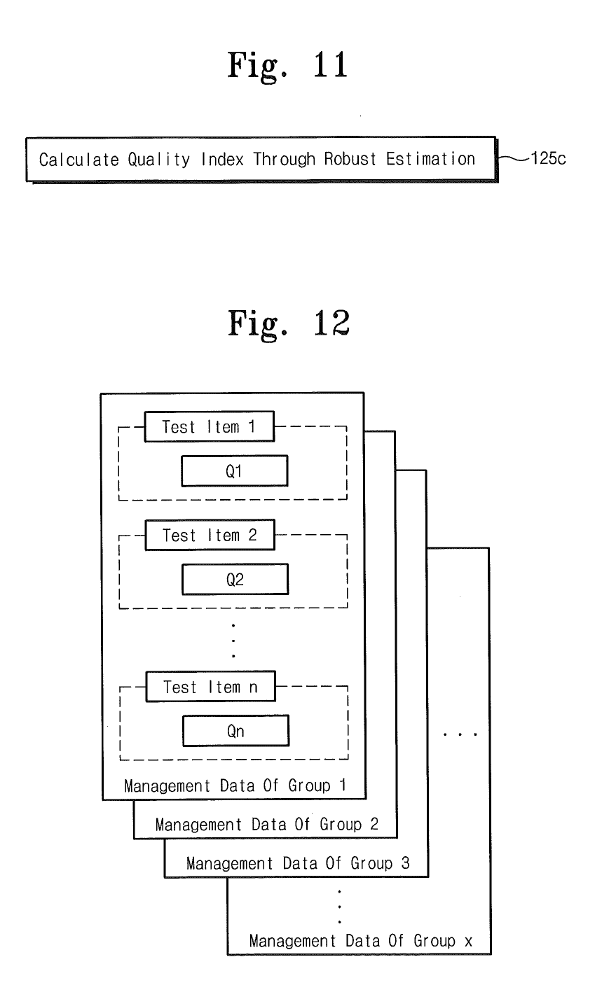

FIG. 9 is a flowchart for exemplarily describing a quality index calculation algorithm which has been described above with reference to FIG. 8. FIGS. 10 and 11 are diagrams for exemplarily describing in more detail the each operation of the quality index calculation algorithm which will be described below with reference to FIG. 9.

Referring to FIG. 9, operation 125 of executing the quality index calculation algorithm may comprise operation 125a of grouping the measurement records comprised in the measurement table (MT) according to a predetermined reference, operation 125b of removing an outlier from the grouped data, and operation 125c of calculating a quality index Q from data from which the outlier has been removed to generate a quality index record QR. Herein, the outlier may be defined as a data value that is numerically separated from the other portions of data.

In the grouping operation 125, the grouping may be performed on the basis of a product group. As illustrated in FIG. 10, the grouping may be understood as an operation of reducing the dimension of a data structure by adding a constraint condition to the product group. Herein, the product group may be determined in consideration of the manufacture operation and production method of a corresponding product, as described above with reference to FIGS. 1 through 4. For example, in the case of touch screen devices integrated in a substrate or semiconductor chips integrated on a wafer, one substrate or one wafer may be used as a criterion of the grouping. According to modified embodiment of the inventive concept, the grouping operation 125a may be performed according to a time reference such as a manufacture time instead of a spatial reference or a modified reference such as a specific manufacture device.

Operation 125a of removing the outlier may be performed to remove noises that are irrelevant to the reliability of a product or the possibility of potential failure of the product. For example, as illustrated in FIG. 10, this operation may exclude measurement values (i.e., the noises) that are considerably greater or less than the other values of data. Excluding the noise may be performed in a scheme that defines a predetermined upper limit and lower limit and removes values deviating from the upper limit or the lower limit. However, the spirit and scope of the inventive concept are not limited to the exemplary method, and the noises may be removed through other various statistical schemes.

Although noises are removed, the distribution curve of much measurement data that is actually obtained may deviate from a normal distribution. For example, as illustrated in FIG. 10, a distribution curve may have an asymmetrical form. In this case, classical statistics, based on the assumption of that data residuals are normally distributed, may not provide an effective result. Because of this reason, operation 125a of calculating the quality index Q according to an embodiment of the inventive concept may be performed in a robust estimation scheme, as illustrated in FIG. 11. The robust estimation scheme may be one of schemes that are used in robust statistics. For example, the quality index may be an M-estimator, a a-trimmed estimator, an R-estimator, an L-estimator or a Winsorised estimator. Since a more detailed description on the robust statistics and the estimators can be easily found through the input of a corresponding term in various search sites (for example, http://en.wikipedia.org/wiki/Robust_statistics and sites linked to this), a description on these will be omitted.

According to one aspect of the inventive concept, data used in the robust estimation operation may be raw data that is obtained from a certain test item for each of the unit products. Herein, the raw data denote one that does not undergo an operation of processing data measured. For example, the evaluation method, which has been described above with reference to FIG. 6, processes measured data according to various sorting references and comprises an operation of again statistically processing the processed data. As described above, it is difficult to use data that is processed on the basis of the sorting reference as the representative value of one product group in that the data is a statistical value for some unit products instead of total unit products. However, in the case of the evaluation method that has been described above with reference to FIGS. 8 and 9, since total raw data obtained from one product group are used for calculating the quality index Q, the quality index may be validly used as the representative value of one product group.

According to another aspect of the inventive concept, source data used in the robust estimation operation may be configured with test results for the fundamental function of the unit product. Herein, the fundamental function of the unit product denotes the intended function of a corresponding unit product. For example, a memory chip comprising a plurality of memory cells is an electronic device for providing a function of storing information in each of the memory cells. In this view, a test result for the fundamental function of the memory chip may be data that is configured to express whether each of the memory cells validly stores information. More specifically, the test operation 25 may comprise an operation of finding a fail bit from memory chips through a certain test.

According to an embodiment of the inventive concept for a memory chip, the source data used in the robust estimation operation may be the numbers of fail bits that have been generated in the memory chips. In this case, the quality index Q obtained through the robust estimation operation may also be obtained as the number of fail bits in a physical meaning, but this value is the representative value of a population configured with total memory chips, which are integrated in one wafer, instead of the memory chips. For example, when the numbers of fail bits generated in the memory chips have a normal distribution, the average value or intermediate value of these may be selected as the quality index Q. Moreover, when the numbers of fail bits generated in each of the memory chips do not have a normal distribution or comprise outliers, a representative value calculated using the robust statistics may be selected as the quality index Q.

The unit products may be tested in many test items for testing the fundamental function in various aspects. As a detailed example, in the case of the memory chip, one memory cell may normally operate when there is no failure in various factors such as the quality of a memory element (for example, the thickness of an information storage layer), the stability of the electrical connection structure of the memory cells (for example, interconnection-via contact quality) and the stability of electrical disconnection between interconnections connecting the memory cells (for example, bridge between interconnections). Accordingly, test items for the memory chip may be configured in order to quantitatively evaluate the factors. In that the quality index is the representative value of the product group obtained in one test item, as illustrated in FIG. 12, a plurality of quality indexes corresponding to the test items can be obtained for one product group.

In that the test items are set in relation to the failure factors, the quality indexes enable to compare the failure factors in product group units. That is, a quality index in a certain test item can quantitatively express whether a corresponding product group is stable by a certain degree in a manufacture process associated with a corresponding test item. As a result, the quality index may be used for process feedback or failure analysis for increasing the stability of a corresponding manufacture process.

FIG. 12 is a diagram for describing the structure of data which is obtained through a method for evaluating the possibility of potential failure of a product according to an embodiment of the inventive concept.

Referring to FIG. 12, as described above, a plurality of quality indexes corresponding to the respective test items may be obtained for one product group. Comparing with data that is obtained from the evaluation method (hereinafter, the SBL technique) using sorted items which has been described above with reference to FIG. 7, one quality index is generated for each test item in the above-described embodiment of the inventive concept, but the SBL technique generates a plurality of analysis data for each test item. Consequently, the above-described technical limitations (for example, the incompleteness of the analysis information, the decrease of efficiency of the evaluation operation and the decrease of accuracy of the evaluation result) existing in the SBL technique can be reduced in the above-described embodiment of the inventive concept.

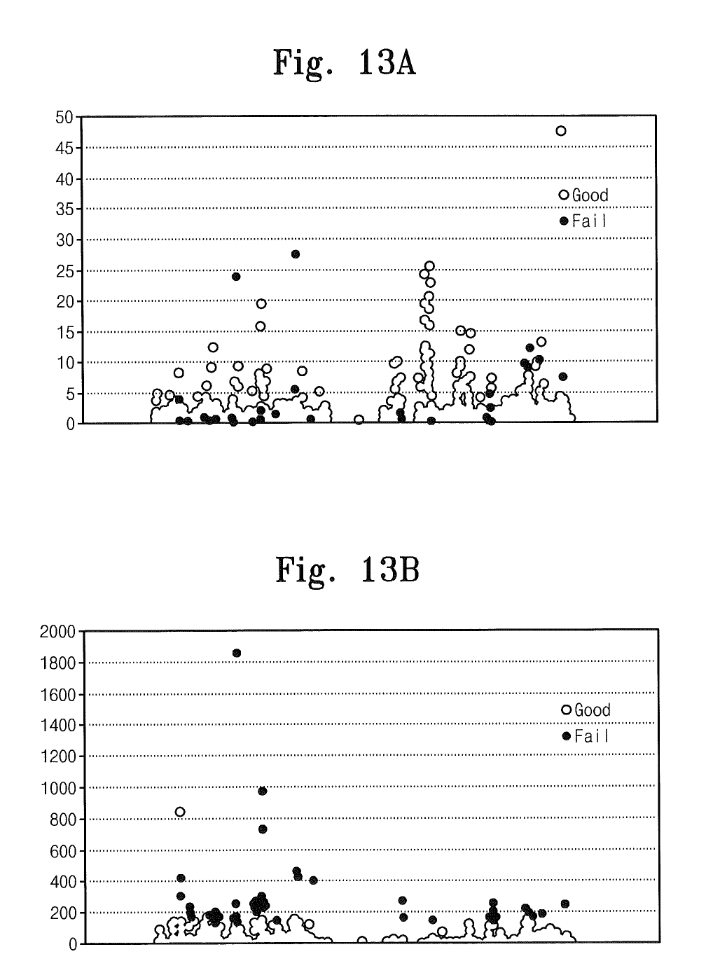

FIG. 13A is a graph illustrating a result which is obtained from the method for evaluating the possibility of potential failure of a product using sorted items, which has been described above with reference to FIG. 6. FIG. 13B is a graph illustrating a result which is obtained from the method for evaluating the possibility of potential failure of a product according to an embodiment of the inventive concept, which has been described above with reference to FIG. 8.

Specifically, FIGS. 13A and 13B illustrate results that are obtained through a test for memory semiconductor chips. FIG. 13A illustrates the analysis result of a result that has been tested in the SBL technique. FIG. 13B illustrates a result showing quality indexes that are obtained in an M-estimate scheme. FIGS. 13A and 13B illustrate results that are obtained from same memory semiconductor chips. In graphs, points depicted as fail indicate wafers that have passed through a test operation but have the failure of a product that has newly occurred in a subsequent operation, and points depicted as good indicate otherwise wafers.

Referring to FIG. 13A that illustrates an evaluation result obtained from the SBL technique, fail points and good points are mixed. Accordingly, wafers having the high possibility of potential failure and otherwise wafers cannot easily be distinguished from the evaluation. Referring to FIG. 13B that illustrates the evaluation result according to an embodiment of the inventive concept, unlike this, fail points are shown in the upper region of the graph, and good points are shown in the lower region of the graph. That is, it can be seen from FIGS. 13A and 13B that the evaluation method according to an embodiment of the inventive concept enables to evaluate the possibility of potential failure of a product with higher discrimination than the SBL technique.

As described above in FIG. 12, since the SBL technique generates more analysis data than the evaluation method according to an embodiment of the inventive concept, the number of points plotted in FIG. 13A is more than that of FIG. 13B.

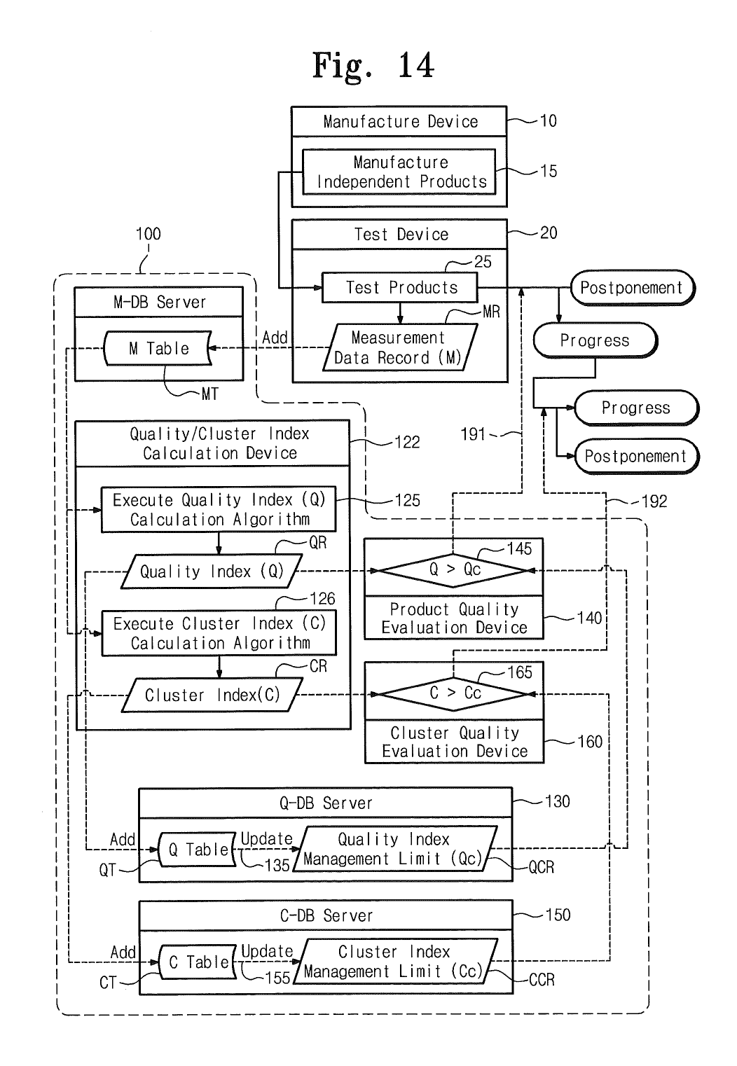

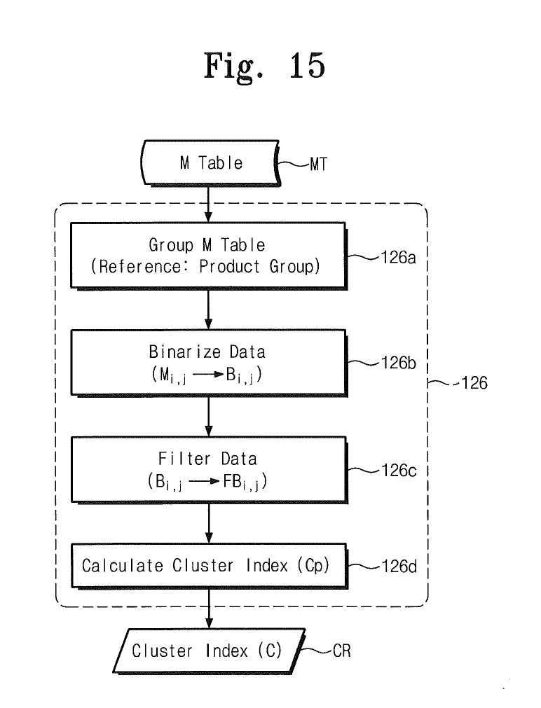

FIG. 14 is a flowchart for describing a method for evaluating the possibility of potential failure of a product and a product sorting method using the same according to another embodiment of the inventive concept. For conciseness, repetitive descriptions on same technical features as those of the embodiment of the inventive concept that has been described above with reference to FIG. 8 will be omitted.

Referring to FIG. 14 and according to this embodiment, executing a cluster index calculation algorithm to calculate a cluster index C from the measurement table in operations 126 is further performed. This operation may be performed through the quality/cluster index calculation device 122 that is configured to perform the quality index calculation algorithm 125 which has been described above with reference to FIG. 8 together. A cluster index record CR comprising the cluster index C may be added to the cluster index table CT of a cluster index database server 150 and be used to update a cluster index management record CCR comprising a cluster index management limit Cc. A cluster quality evaluation device 160 determines whether to progress unit products UP configuring the product group PG on the basis of the cluster index C in operation 192. Operation 192 of determining whether to progress, as shown in operation 165, may be determined through quantitative comparison between the cluster index C and the cluster index management limit Cc.

According to this embodiment, the quality/cluster index calculation device 122 may be a calculation device comprising an algorithm for calculating the quality index and an algorithm for calculating the cluster index, and may electronically communicate with the measurement database server 110, the quality index database server 130 and the product quality evaluation device 140.

According to embodiments of the inventive concept, the cluster index C enables to filter the possibility of potential failure of a product that is not shown by the quality index Q. For example, in the case of the above-exemplified memory chip, the quality index Q provided as a representative value for one wafer may be low when failure chips are clustered in a local region. However, in the case of good chips peripheral to clustered failure chips or repaired good chips, it may be analyzed that there is much possibility that a potential failure occurs within a warranty period. By quantitatively expressing such a clustering trend, the cluster index C enables to additionally filter the possibility of potential failure of a product that is not shown by the quality index Q. For this, operation 192 of determining whether to progress based on the cluster index C may be performed for unit products that have passed through operation 191 of determining whether to progress based on the quality index Q. The algorithm for calculating the cluster index will again be described below with reference to FIGS. 15 through 19.

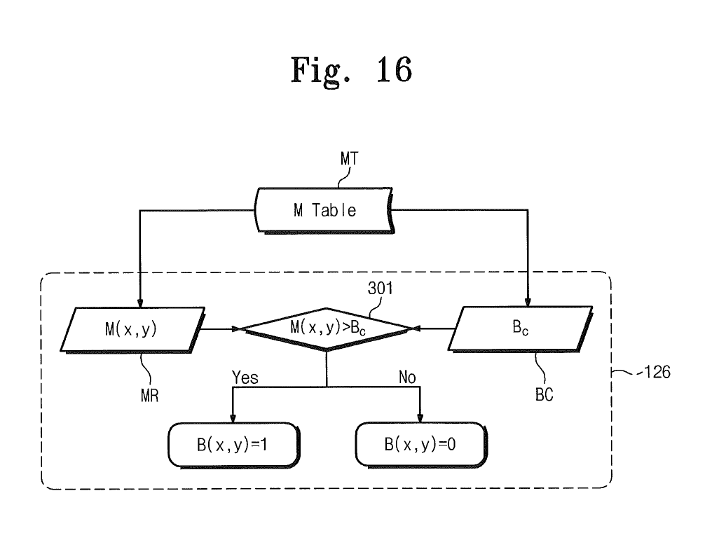

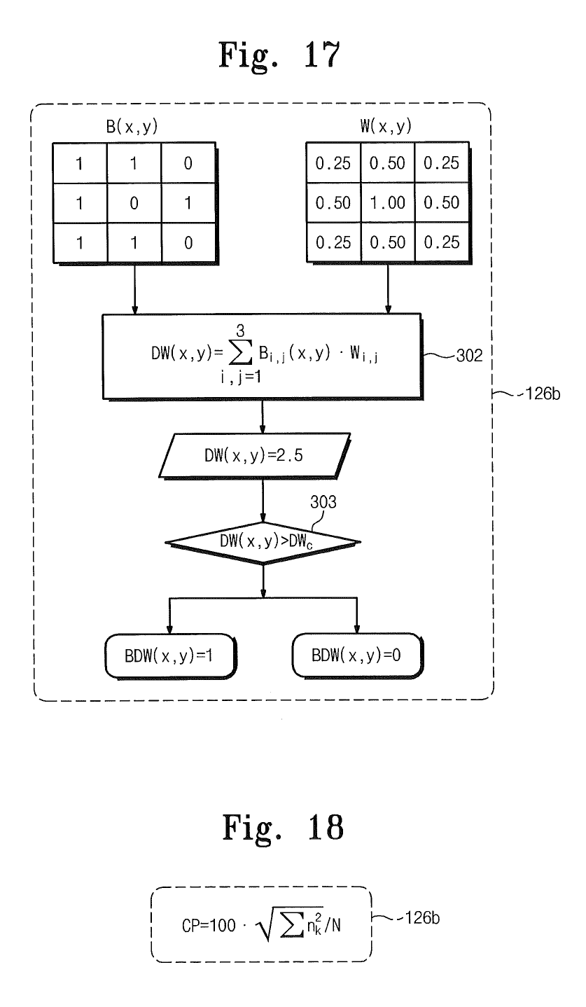

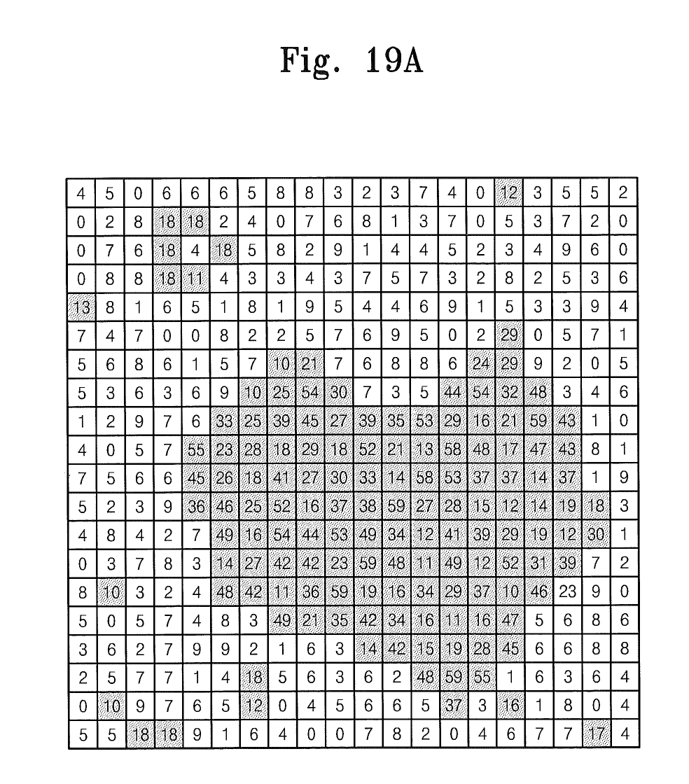

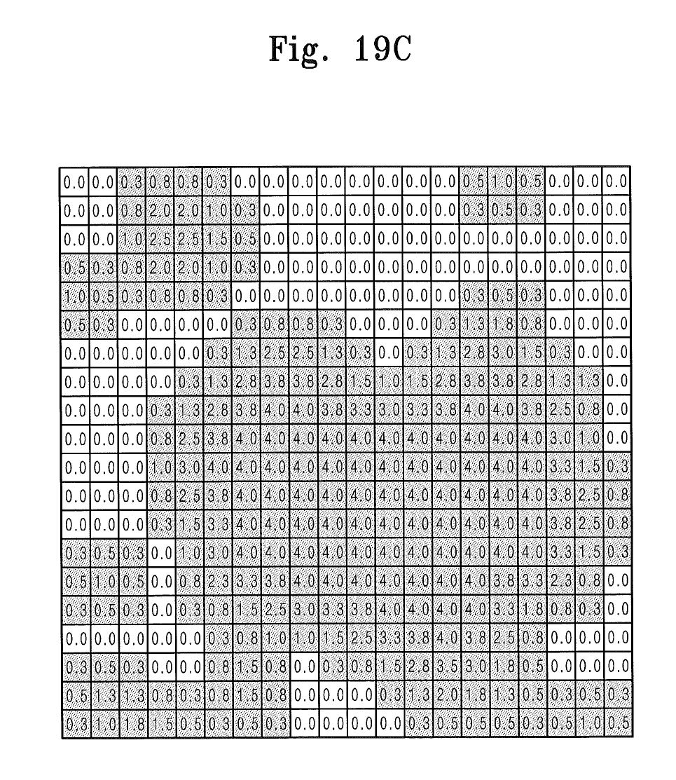

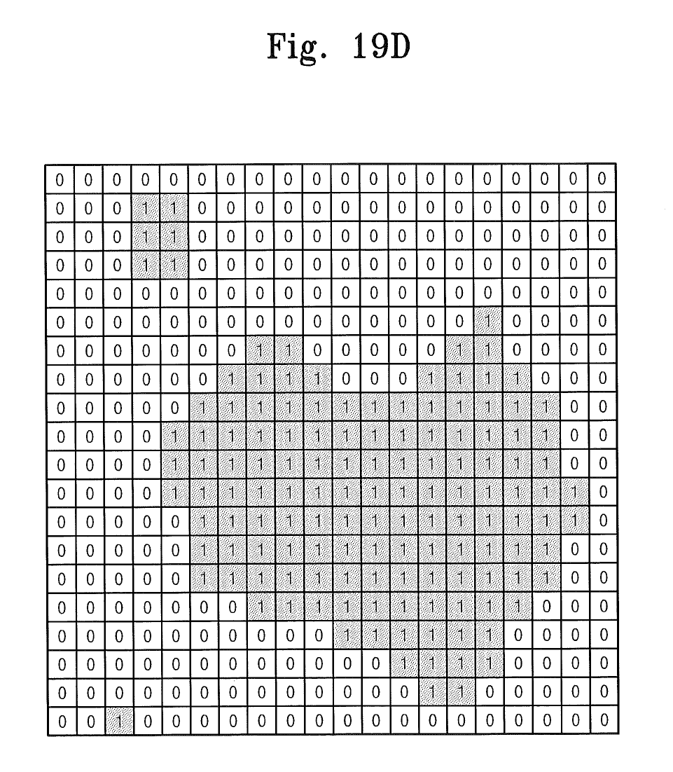

FIG. 15 is a flowchart for exemplarily describing the cluster index calculation algorithm which has been described above with reference to FIG. 14. FIGS. 16 through 18 are diagrams for exemplarily describing in more detail the each operation of a cluster index calculation algorithm which will be described below with reference to FIG. 15. FIGS. 19A though 19D illustrate data maps exemplarily showing a result which is obtained from the each operation of a cluster index calculation algorithm which will be described below with reference to FIG. 15, for describing in more detail the cluster index calculation algorithm.

Referring to FIGS. 15 through 18, operation 126 of calculating the cluster index may comprise operation 126a of grouping the measurement records according to a predetermined reference, operation 126b of binarizing the grouped data, operation 126c of filtering the binary-coded data, and operation 126d of calculating a cluster index from the filtered data.

Grouping operation 126a may be performed in the same scheme as that of grouping operation 125a that has been described above with reference to FIG. 9 or in a scheme that has been modified from it. In this case, one data map corresponding to one product group as illustrated in FIG. 19A may be obtained. In the data map of FIG. 19A, tetragonal pieces (hereinafter referred to as unit regions) correspond to unit products (for example, memory chips integrated on one wafer) configuring one product group, and a numeral written inside the tetragonal piece represents measurement data (for example, the number of fail bits in the case of a memory chip). In this case, each of the measurement data may be given as the function of two-dimensional coordinates (x, y) that describe the location of a corresponding unit product in a corresponding product group.

In binarizing operation 126b, the grouped data may be binarized. In this case, a binary-coded data map as illustrated in FIG. 19B may be obtained. That is, the binary-coded data map may comprise unit regions having one of 0 and 1. As illustrated in FIG. 16, binarizing operation 126b may comprise operation of giving a binary-coded value B(x, y) to each of the unit regions by quantitatively comparing respective measurement data M(x, y) with a predetermined binary reference value Bc, wherein B(x, y) is 0 or 1. The binary reference value Bc may be defined through statistical processing on the measurement table or an engineer's experience. Even when the binary reference value Bc is defined through an engineer's experience, since only one quality index or cluster index according to embodiments of the inventive concept is given for each test item for one product group, the numerals of these are less than the case of SBL technique. The above-described binarizing method has merely been described for exemplarily describing the spirit and scope of the inventive concept, and the spirit and scope of the inventive concept are not limited thereto. Other known binarizing methods may be used instead of the above-described method.

Filtering operation 126c may comprise an operation that calculates a distribution weight value DW that quantitatively expresses a clustering trend, and binarizes the distribution weight value DW to calculate the binary-coded distribution weight value BDW, by using the binary-coded data B(x, y). At this point, the distribution weight value DW and the binary-coded distribution weight value BDW are calculated from each unit region. Consequently, a data map expressing the distribution weight value DW as illustrated in FIG. 19C and a data map expressing the binary-coded distribution weight value BDW as illustrated in FIG. 19D may be obtained.

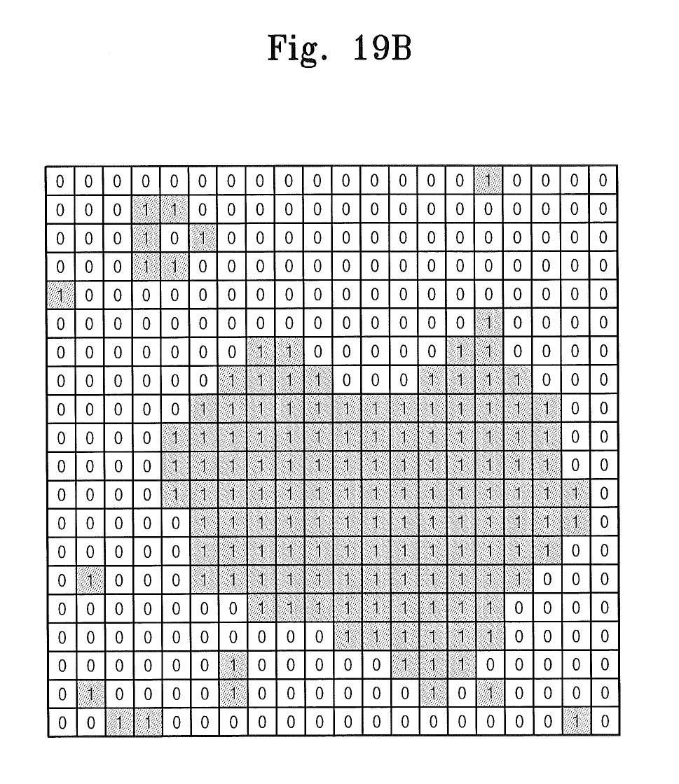

As illustrated in FIG. 17, operation 302 of calculating the distribution weight value DW may comprise operation 302 that manipulates the binary-coded data Bᵢⱼ of a selected unit region and a plurality of unit regions surrounding it with weight data Wᵢⱼ that is defined, based on a relative location for the selected unit region. According to an embodiment of the inventive concept, as illustrated in FIG. 17, the distribution weight value DW(x, y) of the selected unit region may be obtained from the binary-coded data Bᵢⱼ(x, j) and the weight data Wᵢⱼ through Equation (1) below.

$$DW ( x , y ) = {\sum }_{i , j = 1}^{3} {B}_{i , j} ( x , y ) \cdot {W}_{i , j} \qquad ( 1 )$$

An operation of calculating the binary-coded distribution weight value BDW may comprise an operation that gives a binary-coded distribution weight value BDW(x, y) to each of unit regions by quantitatively comparing the distribution weight value DW(x, y) of the selected unit region and a predetermined distribution weight reference DWc, wherein BDW(x, y) is 0 or 1.

Comparing FIGS. 19A and 19D, it can be seen that the data map of FIG. 19D shows a clearer clustering trend than the data map of FIG. 19A. That is, it can be seen that the cluster boundary of the center comprising many unit regions is cleared and a portion of peripheral clusters configured with a small number of unit regions is vanished.

According to an embodiment of the inventive concept, operation 126d of calculating the cluster index may be calculated through an equation that is illustrated in FIG. 18. In FIG. 18, nₖ is the number of unit regions comprised in a kth cluster, and N is the total number of unit products configuring one product group.

Filtering operation 126c and operation 126d of calculating the cluster index have merely been described for exemplarily describing the spirit and scope of the inventive concept, and the spirit and scope of the inventive concept is not limited thereto. Other known binarizing methods may be used instead of the above-described method. According to a modified embodiment of the inventive concept, moreover, the cluster index may be directly obtained from the grouped data without performing at least one of binarizing operation 126b and filtering operation 126c.

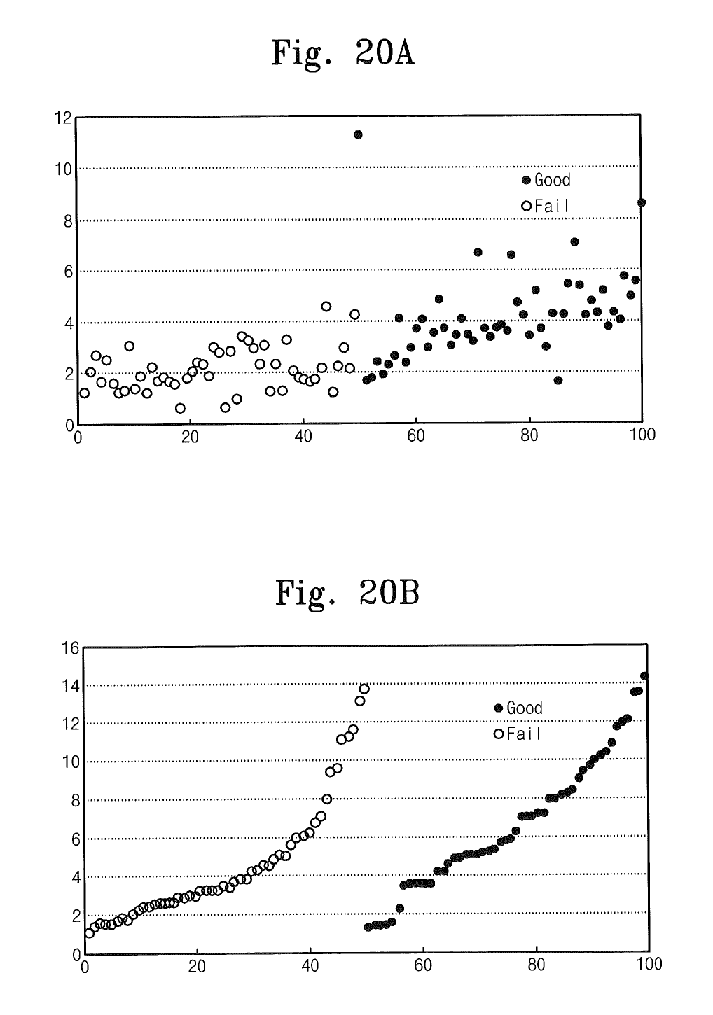

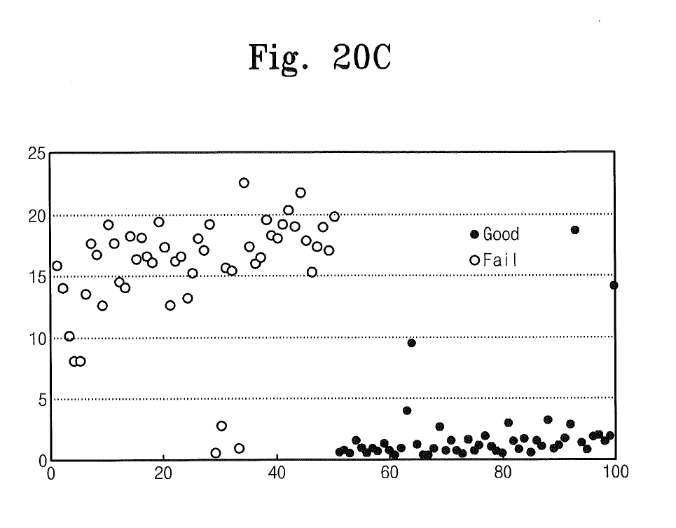

FIGS. 20A through 20C are graphs exemplarily showing the superiority of a cluster index according to an embodiment of the inventive concept. FIG. 20A is a graph showing bin values that are obtained through the SBL technique which has been described above with reference to FIG. 6. FIG. 20B is a graph showing quality indexes that are obtained through the evaluation method which has been described above with reference to FIG. 8. FIG. 20C is a graph showing cluster indexes that are obtained through the method which has been described above with reference to FIG. 15. FIGS. 20A through 20C illustrate results that are obtained from the same measurement data.

In FIGS. 20A and 20B, fail points and good points are mixed by the degree in which they cannot easily be distinguished. The reason that the points of FIG. 20A and the points of FIG. 20B are plotted in different schemes is because there is a difference in the presence of sorting of data. That is, as illustrated in FIGS. 20A and 20B, the evaluation method based on the bin values and the evaluation method based on the quality index could not effectively evaluate the possibility of potential failure of a product group. As a result, the method for evaluating the possibility of potential failure that has been described above with reference to FIG. 8 may provide discrimination as illustrated in FIG. 13B, but may not provide discrimination as illustrated in FIG. 20B depending on the case.

On the other hand, as illustrated in FIG. 20C, the evaluation method based on the cluster index shows a clear difference between product groups having a potential failure and product groups having no potential failure. That is, most of product groups having a potential failure are disposed between cluster indexes 5 to 25, and most of product groups having no potential failure are disposed between cluster indexes 0 to 5.

The reason that the evaluation based on the quality index cannot provide an effective result and the evaluation based on the cluster index cannot provide an effective result is because the quality index cannot effectively express the internal quality of a product group (such as clustering) although it is provided as a representative value for one product group. In this view, the spirit and scope of the inventive concept may be variously modified. For example, in that the cluster index is one expressing one type of the internal quality of the product group, applied may also be other indexes capable of quantifying another type of the internal quality of the product group. According to the spirit and scope of the inventive concept, nevertheless, such indexes may be configured to provide information on total unit products configuring one product group. Unlike this, the SBL technique has a difference with respect to indexes according to the spirit and scope of the inventive concept in that as the result of item sorting, each of the bin values provides partial information on a portion of unit products configuring one product group (i.e., the above-described incompleteness of the analysis information). In similar reason, indexes according to the spirit and scope of the inventive concept can overcome the above-described technical limitations of the SBL technique such as the decrease of efficiency of the evaluation operation and the decrease of accuracy of the evaluation result.

According to embodiments of the inventive concept, the possibility of potential failure of a product is evaluated based on a cluster index. The quality index is provided as a representative value for one product group, and the cluster index is provided as an example of quantification for the internal quality of one product group. The quality index and the cluster index provide information for total unit products configuring one product group. Accordingly, technical limitations, such as the incompleteness of analysis information, the decrease of efficiency of an evaluation operation and the decrease of accuracy of an evaluation result that may arise in the SBL technique for providing partial information on a portion of unit products configuring one product group, can be reduced in the method for evaluating the possibility of potential failure according to embodiments of the inventive concept.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A product sorting method, comprising:
manufacturing a plurality of independent products with a manufacture device;
obtaining test records for the respective products by testing the products with a test device;
determining whether the products are good products or fail products by analyzing the test records with a failure determination device;
calculating a quality index which defines possibility of potential failure of a population comprising the tested products as one value, by analyzing the test records with a quality index calculation device; and
determining whether to perform a subsequent operation for products which are determined as the good products by analyzing the quality index with a product sorting device.

2. The product sorting method of claim 1, wherein:
the products configure a plurality of product groups which are independently manufactured in the manufacture device,
all products comprised in one product group are manufactured through substantially same manufacture process stages, and
the population comprises products which are comprised in one product group.

3. The product sorting method of claim 2, wherein a relative location between the products, which are comprised in one product group, is fixed while the products are being manufactured.

4. The product sorting method of claim 1, wherein the calculating of a quality index comprises:
grouping the test records; and
calculating the quality index by analyzing the grouped test records through robust estimation.

5. The product sorting method of claim 4, wherein the quality index calculated through the robust estimation is any one of an M-estimator, a α-trimmed estimator, an R-estimator, an L-estimator and a Winsorised estimator.

6. The product sorting method of claim 4, wherein:
the products configure a plurality of product groups which are independently manufactured in the manufacture device,
all products comprised in one product group are manufactured through substantially same manufacture process stages, and
the grouping of the test records comprises grouping the test records in product group units.

7. The product sorting method of claim 4, wherein the grouped test records comprise test records obtained from the same test item, for all products satisfying all two cases below.
(1) products which are manufactured through the substantially same manufacture process stages
(2) products in which a relative location is fixed during the manufacture process stage

8. The product sorting method of claim 4, further comprising: grouping the test records, and removing an outlier from the grouped test records.

9. The product sorting method of claim 1, wherein:
the testing of the products comprises measuring qualities of the products for a plurality of test items, and
the quality index is calculated as one value for each of the test items.

10. The product sorting method of claim 1, further comprising: calculating a cluster index which defines a fail clusteringness of the population as one value, by analyzing the test records with a cluster index calculation device.

11. The product sorting method of claim 10, wherein the calculating of a cluster index comprises:
binarizing the test records;
filtering the binary-coded test records; and
calculating the cluster index from the filtered test records.

12. The product sorting method of claim 10, further comprising:
additionally determining whether to perform a subsequent operation for products which are sorted to perform a subsequent operation through an analysis of the quality index, by analyzing the cluster index with the product sorting device.

13. The product sorting method of claim 10, wherein:
the products configure a plurality of product groups which are independently manufactured in the manufacture device,
all products comprised in one product group are manufactured through substantially same manufacture process stages, and
the cluster index is calculated as one value for each of the product groups.
